(19) United States
(12) Patent Application Publication
(10) Pub. No.: US 2025/0317195 A1
(43) Pub. Date: Oct. 9, 2025

(54) LEO CO-CHANNEL INTERFERENCE MANAGEMENT BASED ON STAY-OUT IN UV SPACE

(71) Applicant: Hughes Network Systems, LLC, Germantown, MD (US)

(72) Inventors: Udaya Bhaskar, North Potomac, MD (US); Lin-Nan Lee, Potomac, MD (US); Neal D. Becker, Olney, MD (US)

(21) Appl. No.: 19/097,388

(22) Filed: Apr. 1, 2025

Related U.S. Application Data
(60) Provisional application No. 63/575,049, filed on Apr. 5, 2024.

(51) Int. Cl. H04B 7/185; H04B 7/195

(52) U.S. Cl. CPC H04B 7/18513; H04B 7/18519; H04B 7/195

(57) ABSTRACT

Techniques are described for selecting co-channel cells for a LEO satellite system based on defining stay-out distances in UV space units. For example, “stay-out distance” can be defined as x-dB of beamwidth. Each x-dB in UV space remains substantially constant, regardless of the scan angle of the beam. As such, for any cell, regardless of its location in UV space, the responses of co-channel beams not directed at this cell will have dropped off by a consistent amount over the stay-out distance, and the stay-out distance (e.g., the value of x) can be defined such that the drop-off is sufficient to keep responses of co-channel beams not directed at any particular cell to within an acceptable level of interference.

### CROSS REFERENCE TO RELATED APPLICATIONS

This application claims priority to U.S. Provisional Patent Application No. 63/575,049, filed on Apr. 5, 2024, the disclosure of which is incorporated by reference in its entirety for all purposes.

### BACKGROUND

Low-Earth orbit (LEO) satellites use beamforming to provide coverage to user equipment (UEs) on or close to the ground. Typically, a planar direct radiating array (DRA) antenna with a digital beamformer (DBF) is used to form these beams. The DRA boresite typically points at the subsatellite or nadir point. Each LEO satellite covers a wide field of view (FoV), which requires it to scan several tens of degrees from the nadir point.

The FoV is covered by many beamformed spot beams directed at fixed, uniformly sized cells on the Earth's surface or at UEs located within such cells. Covering the cells within the FoV involves scanning the formed beams from 0 deg at the DRA nadir point to the maximum scan angle at the DRA edge of coverage (EoC). The shape of the formed beams is uniform in the antenna coordinate space (i.e., as projected on a plane parallel to the surface of the planar DRA). However, when projected onto the earth surface (roughly spherical), the beam shapes are non-uniform. Further, the non-uniformity of the beam shape on earth increases with increasing scan angle away from nadir direction. Viewed in an Earth-centric coordinate system, such non-uniformity manifests as elongation or increase in the scanned beam main lobe width increases in the scan angle. Viewed in the antenna coordinate system, the beam width stays constant, but the uniformly spaced cell centers on Earth project to non-uniform spacing in the antenna plane.

### SUMMARY

Systems and methods are described for selecting co-channel cells for a LEO satellite system based on defining stay-out distances in UV space units. For example, “stay-out distance” can be defined as x-dB of beamwidth. Each x-dB in UV space remains substantially constant, regardless of the scan angle of the beam. As such, for any cell, regardless of its location in UV space, the responses of co-channel beams not directed at this cell will have dropped off by a consistent amount over the stay-out distance, and the stay-out distance (e.g., the value of x) can be defined such that the drop-off is sufficient to keep responses of co-channel beams not directed at any particular cell to within an acceptable level of interference.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an illustrative satellite communication system for providing efficient co-channel interference management, according to embodiments described herein.

FIG. 2A shows the field of view (FoV) of a LEO satellite in a latitude-longitude coordinate system.

FIG. 2B shows the cell centers from the perspective of the satellite antenna (DRA) as projected on to an antenna coordinate plane (UV space).

FIG. 3A shows a beam formed at a cell located at the nadir of the DRA.

FIG. 3B shows a beam formed at a cell located in the peripheral region of the DRA.

FIG. 4 shows a flow diagram of an illustrative method for managing co-channel interference in a satellite communication system, according to embodiments described herein.

### DETAILED DESCRIPTION

Maximizing the capacity of a LEO satellite system involves managing the interference between beams by ensuring that beams formed at the same time and using overlapping frequencies (i.e., co-channel beams) do not cause excessive interference to each other. Typically, such interference management includes ensuring that there is sufficient spatial isolation between co-channel beams so that the beam response of a beam is low enough at its co-channel beams to not cause excessive interference.

In terrestrial cellular systems, this is typically enforced by a fixed stay-out distance between cell centers. However, in the case of LEO satellite systems, separating the beam centers based on a fixed stay-out distance based on their terrestrial distance can result in poor performance. This is at least because the beam shape and width change with changes in the satellite antenna's scan angle relative to its nadir point. For example, when beams are formed at the edge of the coverage (EoC) area of a satellite, the projection of the beam onto the Earth's curved surface becomes elongated, and the spacing between cell centers becomes compressed in certain regions. This variation in beam shape and cell center spacing necessitates a more dynamic approach to interference management that accounts for these scan-dependent characteristics.

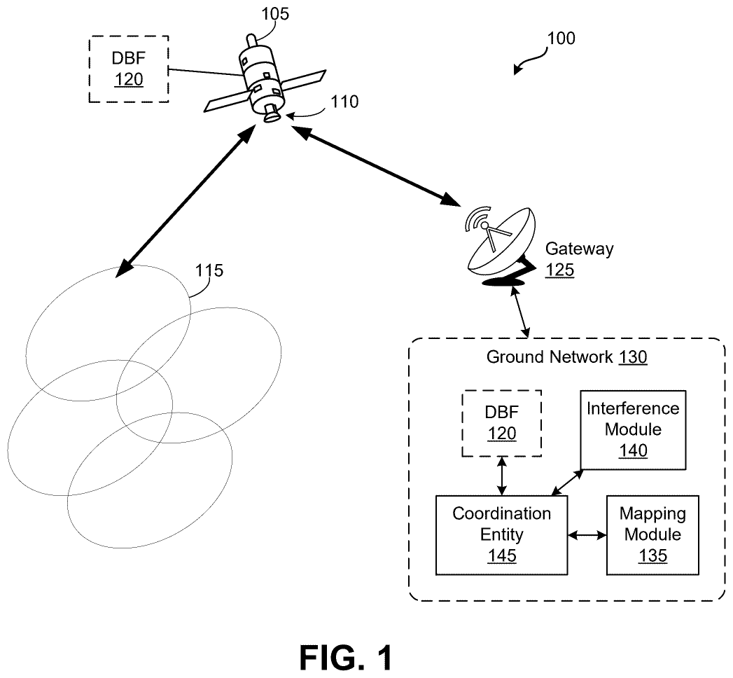

FIG. 1 shows an illustrative satellite communication system 100 for providing efficient co-channel interference management, according to embodiments described herein. The system includes a satellite 105 configured to provide coverage to a plurality of cells 115 on the surface of the Earth. The satellite 105 is equipped with a satellite antenna 110 and a digital beamformer (DBF) 120, both of which work in conjunction to form and direct beams that illuminate cells 115 (i.e., corresponding to beam coverage areas). A ground network 130 includes a mapping module 135, an interference module 140, and a coordination entity 145. The ground network 130 communicates with the satellite 105 via a gateway 125.

Although one satellite 105 and one gateway 125 are shown, embodiments of the satellite communication system 100 can include multiple satellites 105 in communication with the ground network 130 via one or more gateways 125. For example, the satellite communication system 100 can include a constellation of satellites 105 in communication with components of the ground network 130 via multiple, geographically distributed gateways 125.

Embodiments of the satellite 105 are implemented as a low-Earth orbit (LEO) satellite that operates at an altitude of several hundred kilometers above the Earth's surface, enabling low-latency communication with user equipment (UEs) located within the cells 115. The satellite 105 moves rapidly relative to the Earth's surface, requiring dynamic beamforming and frequency allocation to maintain continuous coverage as it traverses its orbital path. The satellite 105 is equipped with onboard power systems, communication subsystems, and computational resources necessary to operate the satellite antenna 110 and the DBF 120.

The satellite antenna 110 is a planar direct radiating array (DRA) antenna that uses beamforming to provide coverage to the cells 115. The DRA consists of a matrix of radiating elements, each capable of being individually controlled to shape and steer beams. The satellite antenna 110 generates a plurality of beams that collectively cover the satellite's field of view (FoV). The FoV extends from the nadir point (directly beneath the satellite) to the edge of coverage (EoC), requiring the beams to be scanned over several tens of degrees. The satellite antenna 110 operates in conjunction with the DBF 120 to form and direct the beams, ensuring that the beam shapes remain uniform in the antenna's coordinate system (UV space) while adapting to the non-uniform projection of the beams onto the Earth's curved surface.

Descriptions herein refer to “UV coordinates,” a “UV coordinate system,” “UV space,” and the like. “UV” is conventionally used in these contexts as a two-dimensional, normalized coordinate system to describe angular directions of beams in relation to an antenna. The UV coordinates are derived from the spherical coordinate system, which uses azimuth and elevation angles to define directions in three-dimensional space. Specifically, the UV coordinates are defined mathematically as U=sin θ cos φ and U=sin θ sin φ, where θ is the elevation angle relative to the antenna's boresight (the direction the antenna is pointing) and φ is the azimuth angle. This transformation maps angular directions onto a planar coordinate system, where the U and V axes correspond to orthogonal directions in the antenna's angular field of view. In this representation, beam patterns maintain a uniform shape in UV space, regardless of their scan angle or position, which makes the UV coordinate system particularly useful for analyzing and managing beam interference in satellite communication systems.

The digital beamformer (DBF) 120 is responsible for controlling the direction, shape, and frequency allocation of the beams generated by the satellite antenna 110. The DBF 120 operates by applying phase and amplitude adjustments to the signals fed to the radiating elements of the DRA, enabling precise control over the beam patterns. The DBFs 120 are configured to form beams that are compliant with the stay-out distance in the UV coordinate system, ensuring spatial isolation between co-channel beams.

The DBF 120 can implement various beamforming algorithms. Some embodiments implement advanced beamforming algorithms, such as adaptive beamforming or minimum variance distortionless response (MVDR), to optimize the beam patterns for interference mitigation and coverage efficiency. Other embodiments can implement eigenvector-based beamforming for interference minimization or least-squares beamforming for optimal beam shaping. Embodiments of the DBFs 120 receive frequency assignments and stay-out distance parameters from the interference management module and adjust the beamforming weights accordingly to ensure compliance with interference criteria. The DBFs 120 may use high-performance digital signal processors (DSPs) or field-programmable gate arrays (FPGAs) to achieve real-time beam adjustments.

In some implementations, the DBF 120 adjusts beamforming parameters dynamically in response to real-time data received from the ground network 130 or onboard sensors, allowing the system to adapt to changing interference conditions or scan loss effects at higher scan angles.

FIG. 1 illustrates the DBF 120 optionally in different locations. In some embodiments, the DBF 120 is implemented onboard the satellite 105. In other embodiments, the DBF 120 is implemented on the ground in the form of a ground-based beamformer (GBBF), where beamforming parameters are calculated on the ground and transmitted to the satellite for execution. Other embodiments include a hybrid implementation of the DBF 120 that uses a combination of on-board and ground-based beamforming.

The ground network 130 provides control and processing for the satellite communication system 100. It includes some or all of the mapping module 135, the interference module 140, and the coordination entity 145, all of which work together to manage interference and optimize the system's overall performance. The ground network 130 communicates with the satellite 105 via the gateway 125 (or with multiple satellites 105 via one or more gateways 125), which provides a high-bandwidth link for transmitting data, control signals, and beamforming parameters between the satellite and the ground.

Some embodiments of the satellite communication system 100 include a single instance of the ground network 130 components, such as for centralized control and processing. In other embodiments, the satellite communication system 100 includes multiple instances of one or more components of the ground network 130 for more distributed control and/or processing. While the gateway 125 is shown as separate from the ground network 130, embodiments can implement one or more of the ground network 130 components in the gateway 125. For example, each of one or gateways 125 can include an instance of the mapping module 135 and the interference module 140, and those components, and each of the one or more gateways 125 is in communication with the one or more coordination entity 145 instances. Further, although any particular component is shown as a single “box,” the component can include multiple, functionally distributed sub-components. For example, embodiments of the coordination entity 145 can include a centralized sub-component of the coordination entity 145 that manages higher level and/or less real-time coordination and processing functions, and each of the one or more gateways 125 can include a distributed sub-component of the coordination entity 145 that manages lower level and/or more real-time coordination and processing functions.

The mapping module 135 is responsible for determining the locations of the cells 115 in the satellite's field of view and mapping these locations from a latitude-longitude coordinate system to the UV-coordinate system of the satellite antenna 110. This mapping process involves the use of satellite ephemeris data, which provides information about the satellite's position, attitude, and velocity. For example, the mapping module can use satellite position and orientation data to first transform latitude-longitude coordinates into Earth-centered Cartesian coordinates. Then, the Cartesian coordinates are projected into the antenna's coordinate system using the known position and attitude of the satellite. This mapping can ensure that the UV coordinates accurately represent angular beam directions relative to the antenna.

The mapping module 135 performs geometric transformations to account for the curvature of the Earth and the satellite's relative position, projecting the cell locations onto the antenna coordinate plane (UV space). The UV-space mapping ensures that the system can accurately account for the compression of cell spacing near the periphery of the FoV and the elongation of beam footprints on the Earth's surface. Although FIG. 1 shows the mapping module 135 as part of the ground network 130, embodiments can implement some or all features of the mapping module 135 on-board the satellite(s) 105.

The interference module 140 enforces interference management by defining and applying a stay-out distance in UV space between co-channel cells. The stay-out distance is based on an X-dB beamwidth in UV space, where X represents a predefined interference threshold (e.g., 25 dB). The interference module 140 ensures that co-channel cells are separated by at least the stay-out distance in UV space, regardless of their locations in latitude-longitude coordinates. This process involves calculating the UV coordinates of the cells and evaluating potential interference between beams. The interference module 140 can also dynamically adjust the stay-out distance based on scan-angle-dependent factors, such as beam attenuation or compression of cell center spacing, helping to ensure robust interference mitigation across all scan angles. Although FIG. 1 shows the interference module 140 as part of the ground network 130, embodiments can implement some or all features of the interference module 140 on-board the satellite(s) 105.

The coordination entity 145 is responsible for managing interference across the entire constellation of satellites in the system, such as by coordinating with the interference management module 140 to generate frequency assignments across the constellation, ensuring compliance with the stay-out distance in the UV coordinate system. For example, the coordination entity 145 collects ephemeris data, cell-to-satellite associations, and UV-space projections for all satellites in the constellation. Using this data, the coordination entity 145 evaluates potential interference between co-channel beams of adjacent satellites and assigns frequencies to ensure compliance with the stay-out distance criteria. The coordination entity 145 can also reassign beam frequencies dynamically in response to changes in satellite positions, coverage areas, or interference conditions.

Although the coordination entity 145 is shown in FIG. 1 as being located within the ground network 130, it could alternatively be distributed across the satellites themselves via intersatellite links (ISLs), enabling decentralized interference management. In some embodiments, the coordination entity 145 operates as a centralized system located on the ground, aggregating data from all satellites in the constellation (e.g., and/or from multiple constellations, etc.). In other embodiments, the coordination entity 145 is distributed across satellites, with each satellite contributing to interference management via inter-satellite communication links. The coordination entity 145 can implement graph-based algorithms, machine learning models, and/or heuristic methods to ensure efficient frequency allocation across the constellation.

The gateway 125 serves as the communication interface between the satellite 105 and the ground network 130. It provides a high-bandwidth link for transmitting control signals, beamforming parameters, and interference management data between the satellite and the ground. The gateway 125 may also handle uplink and downlink traffic to and from user equipment (UEs) located within the cells 115. The cells 115 are the coverage areas illuminated by the beams generated by the satellite antenna 110. Each cell 115 represents a fixed geographic region on the Earth's surface or a dynamically assigned region based on the beam's current position and orientation. The size and shape of the cells 115 vary depending on the scan angle and the projection of the beams onto the Earth's curved surface, with cells near the periphery of the FoV being more elongated due to the compression effect in UV space.

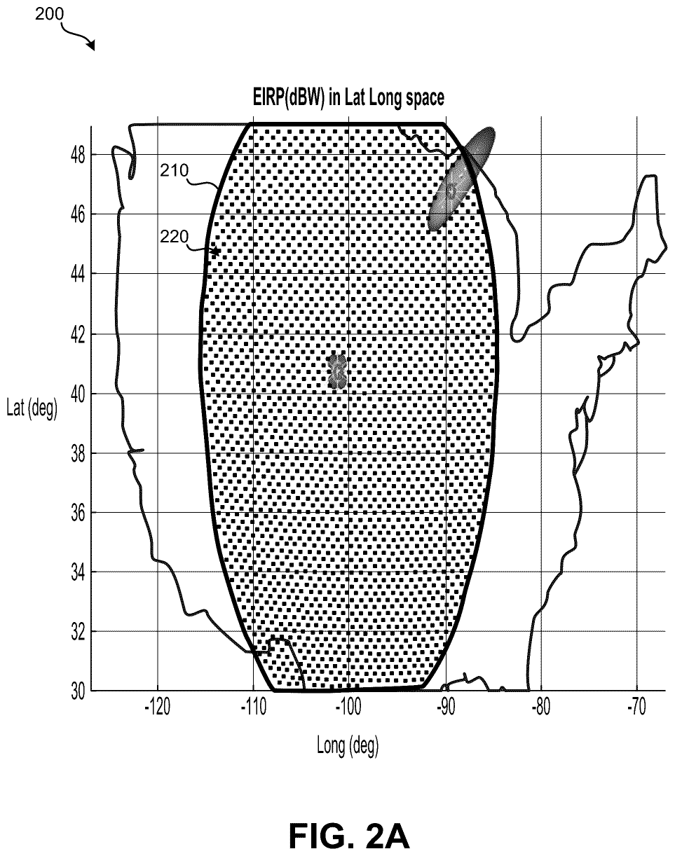

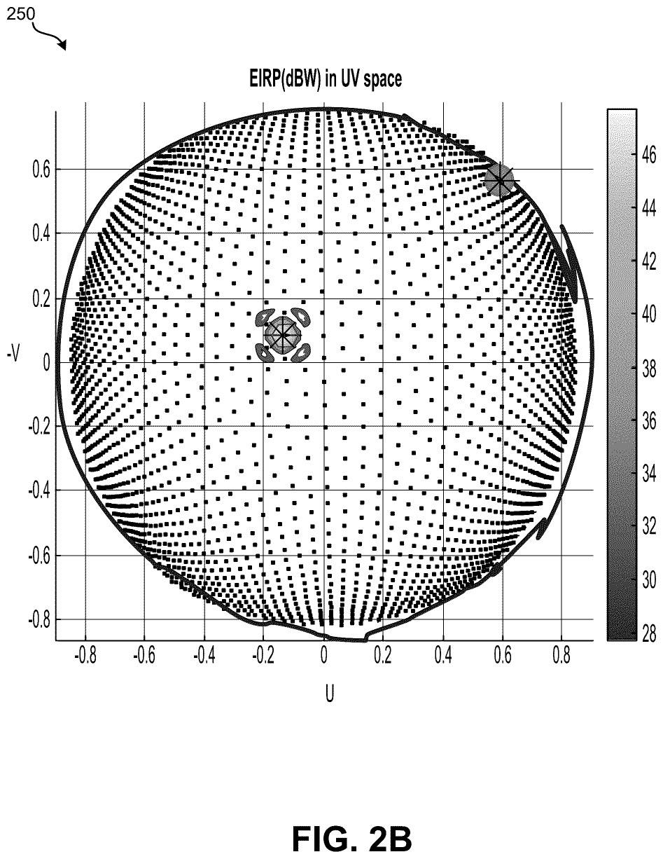

FIG. 2A shows the field of view (FoV) of a LEO satellite 210 in a latitude-longitude coordinate system in graph 200. It can be seen that the cell centers 220 are uniformly spaced. FIG. 2B shows the same cell centers from the perspective of the satellite antenna (DRA) as projected onto an antenna coordinate plane (UV space) in graph 250. It can be seen that the same cell spacing is non-uniform in the antenna coordinate system; cell spacing closer to the periphery of the FoV is significantly compressed as compared to cell spacing near the nadir (i.e., at U=0, V=0). This compression in UV space reflects the scan-dependent variation in beam shapes, which presents challenges for interference management if fixed terrestrial distances are used.

Embodiments herein provide a novel approach to selecting co-channel cells for a LEO satellite system based on defining stay-out distances in UV space units. Some implementations define “stay-out distance” as x-dB of beamwidth. For example, x=25 dB. Each x-dB in UV space remains substantially constant, regardless of the scan angle of the beam. This means that for any cell, regardless of its location in UV space, the responses of co-channel beams not directed at this cell will have dropped off by a consistent amount over the stay-out distance. The stay-out distance (e.g., the value of x) can be defined such that the drop-off is sufficient to keep responses of co-channel beams not directed at any particular cell to within an acceptable level of interference. From a latitude-longitude coordinate perspective, such a stay-out distance definition naturally results in an increase in cell separation between co-channel beams as the scan angle increases.

In addition to defining stay-out distance as x-dB of beamwidth in UV space, several alternative approaches for defining the stay-out distance can be used in embodiments. One such alternative involves defining the stay-out distance as the angular separation between the pointing directions of co-channel beams in UV space. In this implementation, the angular distance is measured in degrees or radians between the central axes of the beams as projected in UV space. This method provides a straightforward geometric measure of separation and can be implemented using the beam pointing vectors. The angular separation could be fixed, such as a predetermined value ensuring sufficient isolation, or it could be dynamically adjusted based on operational factors, including the satellite altitude or the desired interference threshold. This approach ensures spatial isolation between beams while simplifying the calculations needed to enforce the stay-out distance.

Another approach defines the stay-out distance based on a normalized power overlap criterion between the main lobes of co-channel beams. In this approach, the stay-out distance is determined by limiting the power contribution of one beam at the center of a co-channel cell from another beam to a predefined interference threshold, such as −30 dB relative to the peak of the main beam. This ensures that the overlap of power between co-channel beams remains below an acceptable level of interference. This approach accounts for the actual beam pattern characteristics and provides a direct interference-based measure of separation. For example, the system may calculate the interference contribution of a beam at the UV-space coordinates of a neighboring cell and enforce a stay-out distance that minimizes this contribution to the desired threshold. As an example use case, if the main beam's peak power is 0 dBm and the interference threshold is-30 dBm, the stay-out distance is calculated such that the power contribution at the neighboring cell's center does not exceed this threshold.

The stay-out distance can also be defined as the geographic distance between the centers of co-channel cells on the Earth's surface. In this implementation, the system enforces a minimum separation between the projected cell centers in latitude-longitude coordinates, such as 100 kilometers. This approach is intuitive and straightforward to implement in systems where geographic spacing is a primary concern. However, it may be less effective in accounting for the distortion of beam shapes and the compression of cell spacing in UV space, particularly at higher scan angles. For example, such an approach can be used in hybrid systems where geographic constraints supplement UV-space-based interference management.

A more dynamic alternative involves defining the stay-out distance based on a required signal-to-interference ratio (SIR) at the edge or center of a cell. In this implementation, the system calculates the interference levels caused by co-channel beams and adjusts the stay-out distance to ensure the SIR remains above a predefined threshold, such as 20 dB. This approach directly ties the stay-out distance to system performance metrics, such as data throughput or quality of service, and allows for adaptive interference management based on real-time system conditions. By dynamically enforcing an SIR-based stay-out distance, the system ensures that the performance requirements of the communication system are met under varying interference conditions.

In another approach, the stay-out distance is defined by aligning the nulls of one beam's pattern with the main lobe of a co-channel beam. This method exploits the natural attenuation in the beam pattern to minimize interference. For instance, the system may adjust the pointing directions of co-channel beams such that the nulls in one beam's sidelobes coincide with the center of the neighboring cell. This approach minimizes interference without requiring strict separation of beam centers, making it especially useful for systems with advanced beamforming capabilities. Such an approach may rely on precise control over the sidelobe characteristics of the beams and may therefore be implemented in systems capable of generating highly directive beam patterns.

Real-time dynamic interference mapping provides yet another alternative for defining the stay-out distance. In this approach, the system continuously monitors interference levels using feedback from user equipment (UEs) or ground stations and dynamically adjusts the separation between co-channel beams to minimize detected interference. For example, embodiments can use real-time measurements of interference levels at the cell edges to refine the stay-out distance in response to changing environmental or operational conditions. This adaptive approach ensures that the stay-out distance is optimized for current system performance, though it requires sophisticated feedback mechanisms and additional computational resources.

The stay-out distance can also be defined using a frequency reuse factor, in which co-channel cells are separated by a specific number of intervening tiers of cells. For example, the system may enforce a rule that co-channel beams are assigned to cells separated by at least two tiers in either the Earth's coordinate system or UV space. This frequency reuse approach leverages established principles from terrestrial cellular networks and provides a simple and systematic way to manage interference. While it may not fully account for the unique characteristics of LEO satellite systems, such as scan-dependent distortions, it can serve as a complement to more dynamic interference management techniques.

Another approach defines the stay-out distance based on the energy contribution of a co-channel beam at the edge of a neighboring cell. For example, the system could enforce a stay-out distance such that the energy at the cell edge does not exceed a predefined threshold, such as −40 dBm. This approach ensures that interference levels experienced by UEs at the most vulnerable part of the cell remain within acceptable limits. By focusing on the edge of the cell, such an approach tends to address the areas most likely to experience performance degradation due to interference.

A weighted distance metric offers a flexible and comprehensive way to define the stay-out distance. In this approach, the system calculates a composite metric based on a combination of factors, such as UV-space distance, angular separation, and power overlap. Weights are assigned to each factor based on its relative importance to the system's interference management goals. For instance, UV-space distance may be given a higher weight for managing beam distortion effects, while power overlap may be prioritized in regions with high interference levels. This allows for a tailored approach to defining the stay-out distance, though it can rely on careful tuning of the weighting factors and additional computational resources.

In another approach, the stay-out distance can be defined using machine learning-based optimization. In this approach, a machine learning model, such as a neural network, is trained on historical data or simulations to predict the optimal stay-out distance for various beam configurations, scan angles, and interference conditions. Such an approach can use the trained model to dynamically adjust the stay-out distance in real time, accounting for complex, non-linear relationships between system parameters. This approach can offer significant flexibility and adaptability, in exchange for a reliance on substantial amounts of training data and computational resources for real-time implementation.

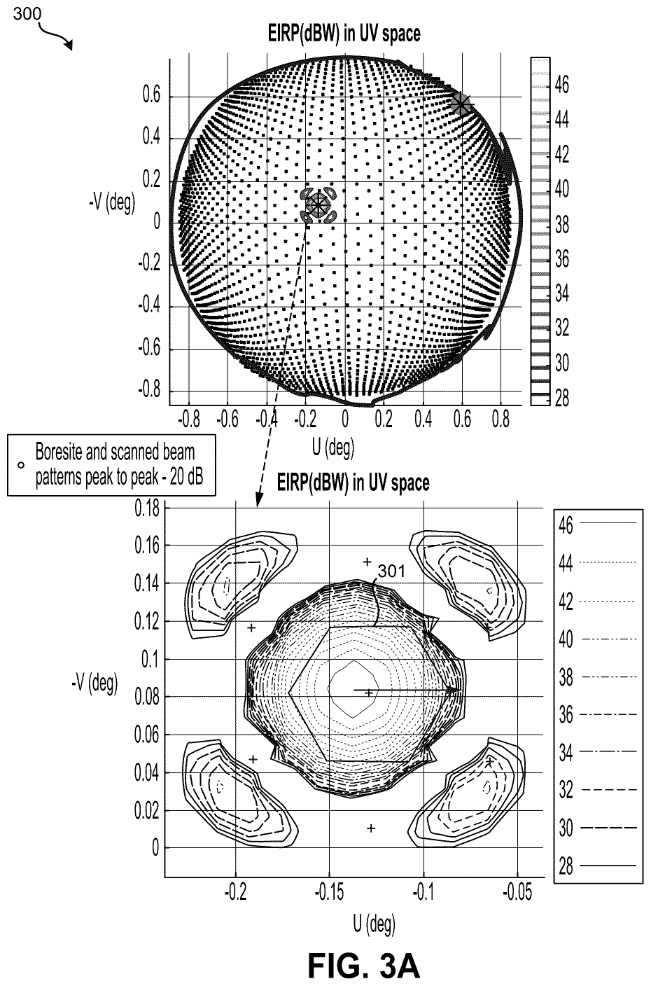

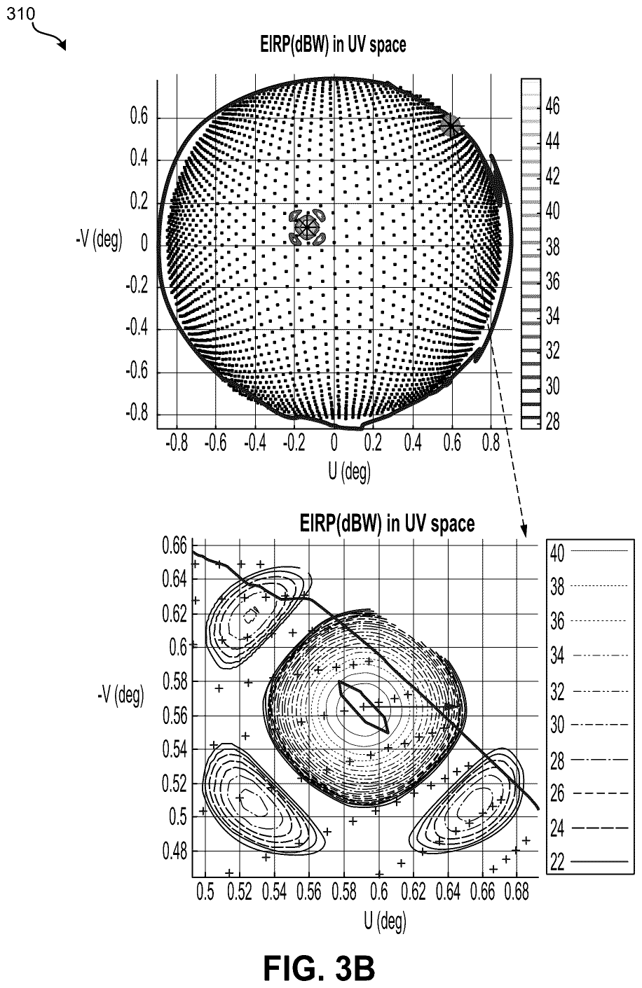

FIG. 3A illustrates graphs 300 of a beam formed at a cell located at the nadir of the DRA. It can be seen that the cell is within the beam main lobe and adjacent cells (indicated by purple ‘+’) are well outside the main lobe. In contrast, FIG. 3B illustrates graphs 310 of a beam formed at a cell located in the peripheral region of the DRA. It is seen many cell centers are within the mainlobe. This demonstrates that while the cell at the center of the mainbeam (region 301) is being served, it may not be possible to serve any of the other cells inside the mainlobe at the same time and using the same frequencies (i.e., without causing excessive interference).

Thus, FIGS. 2A-3B demonstrate that using a fixed Earth-based distance separation between cells in the context of a LEO satellite system can result in considerable interference concerns and/or considerable inefficiencies.

In some embodiments, the stay-out distance is fixed over the scan (i.e., the value of x remains constant over all scan angles). In other embodiments, the stay-out distance is variable over the scan based on one or more scan-angle-dependent factors. For example, scan loss can change with scan angle, and embodiments can vary the stay-out distance at different scan angles based on the respective scan loss at those scan angles. At larger scan angles, the compression of cell centers in UV space and the attenuation of beam response may require a larger stay-out distance to ensure sufficient spatial isolation. For instance, while a stay-out distance of 25 dB may suffice at smaller scan angles, a 30-dB stay-out distance may be more appropriate at higher scan angles to account for increased interference risks.

In some embodiments, the UV coordinates of cells can be determined by an on-ground entity when selecting co-channel beam assignments. For example, the on-ground entity can use satellite ephemeris and cell Earth location (e.g., in latitude and longitude) data to map the cell locations into the UV coordinate system. Once the UV coordinates are determined, the stay-out distance can be enforced to select co-channel cells that meet the interference criteria. This approach ensures that only non-overlapping beams are assigned to co-channel cells, even as the satellite moves and its FoV changes dynamically.

Some implementations of the above apply to co-channel beams from a single LEO satellite. Other implementations can further consider potentially interfering beams from other LEO satellites. For example, a LEO constellation can include a large number of LEO satellites that use the same time-frequency resources. When coverage areas of multiple LEO satellites are adjacent, there is the possibility of excessive co-channel interference between peripheral cells being served by different LEO satellites of the constellation. In such cases, the UV-based stay-out distance approach can be extended to coordinate the selection of co-channel beams among adjacent satellites.

The novel stay-out distance approach described herein can be extended to coordinate the selection of co-channel beams among adjacent satellites of a constellation to manage interference between them. In such cases, the co-channel cells covered by adjacent LEO satellites are also projected to the UV space of each LEO satellite to determine if they meet the UV-based stay-out distance criterion. A central entity that has information about the ephemeris of all the LEO satellites and all the cell-to-satellite associations selects co-channel cells for all the LEO satellites. This central entity aggregates data from all satellites, including their UV-space projections, and evaluates potential interference between adjacent satellites. When a conflict arises between the co-channel beams of adjacent satellites, the central entity reassigns beams to maintain the required stay-out distance in UV space. For example, FIG. 2B illustrates how the UV-space projections of adjacent satellites can overlap, necessitating coordination to prevent interference.

Embodiments are implemented using a digital beamformer (DBF) that dynamically adjusts beam directions and shapes to optimize interference management. The DBF employs beamforming algorithms, such as adaptive beamforming or minimum variance distortionless response (MVDR), to precisely control beam patterns. For example, at larger scan angles, the beam response may decrease due to scan loss, and the DBF compensates for this by adjusting the beamforming parameters. The DBF hardware includes programmable digital filters and phase shifters, enabling real-time adaptation to changing interference conditions.

Embodiments described herein enable robust interference management by leveraging the unique properties of UV space. By dynamically adjusting beam assignments and coordinating interference management across multiple satellites, embodiments help to ensure efficient utilization of satellite resources while minimizing interference. While embodiments are described with reference to LEO satellite networks, embodiments can be extended to other types of networks. In some such embodiments, UV-based stay-out distance approaches described herein are applied to high-altitude platforms (HAPs). In other such embodiments, UV-based stay-out distance approaches described herein are applied to non-terrestrial networks (NTNs), such as defined by 3GPP standards.

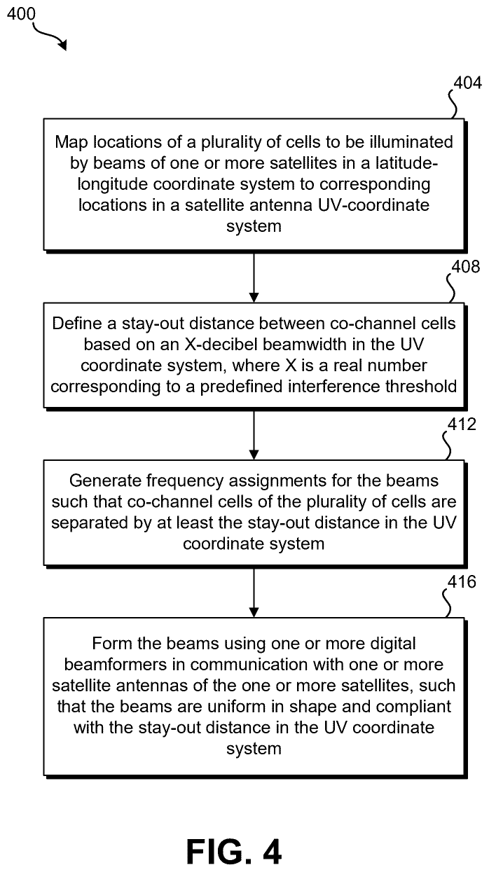

FIG. 4 shows a flow diagram of an illustrative method 400 for managing co-channel interference in a satellite communication system, according to embodiments described herein. Embodiments begin at stage 404 by mapping locations of a plurality of cells to be illuminated by beams of one or more satellites in a latitude-longitude coordinate system to corresponding locations in a satellite antenna UV-coordinate system. This mapping process can begin with identifying the geographic locations of the cells in latitude-longitude coordinates, which correspond to fixed areas on the Earth's surface or dynamically allocated regions based on the satellite's coverage. The mapping can involve converting these geographic coordinates into UV coordinates, which represent normalized angular directions relative to the satellite antenna.

In some implementations, the transformation accounts for the satellite's ephemeris data (e.g., including position, attitude, and velocity) and/or the curvature of the Earth. Embodiments include normalization to ensure that beam shapes remain uniform in UV space, even as they project non-uniformly onto the Earth's surface. Additional refinements, such as accounting for variations in satellite altitude or orbital dynamics, can further enhance the accuracy of the mapping process.

In stage 408, embodiments can define a stay-out distance between co-channel cells based on an X-decibel beamwidth in the UV coordinate system (X is a real number corresponding to a predefined interference threshold). The stay-out distance represents the minimum separation required between the centers of co-channel beams in UV space to ensure that interference levels remain within acceptable limits. The X-decibel beamwidth defines the drop-off in beam response at the edges of the beam's coverage area, with typical values such as X=25 dB being used to maintain adequate isolation.

Stage 408 can involve calculating the UV-space distance between co-channel cells and ensuring that this distance meets or exceeds the stay-out distance. Using a UV-based approach can effective account for the compression of cell spacing at the periphery of the satellite's field of view (FoV) and the distortion of beam shapes due to scan angles. Alternative implementations may dynamically adjust the stay-out distance based on real-time interference conditions or scan-angle-dependent factors, such as beam attenuation or signal-to-interference ratio (SIR) thresholds.

In stage 412, embodiments can generate frequency assignments for the beams such that co-channel cells of the plurality of cells are separated by at least the stay-out distance in the UV coordinate system. Stage 412 can involve assigning time-frequency resources to beams in a manner that ensures compliance with the UV-based stay-out distance. Frequency assignment may be performed by an interference management module, which evaluates the UV-space coordinates of the cells and determines the optimal allocation of frequencies to minimize interference.

Stage 412 can incorporate additional constraints, such as frequency reuse patterns or geographic separation requirements, to further enhance system performance. In some embodiments, a coordination entity may oversee the frequency assignment process across a constellation of satellites, ensuring that the stay-out distance is maintained even in regions where the coverage areas of adjacent satellites overlap. Advanced implementations may use machine learning models trained on historical data to predict optimal frequency assignments based on beam configurations and interference patterns.

In stage 416, embodiments can form the beams using one or more digital beamformers (DBFs) in communication with one or more satellite antennas of the one or more satellites, such that the beams are uniform in shape and compliant with the stay-out distance in the UV coordinate system. The DBFs control the amplitude and phase of the signals fed to the radiating elements of the satellite antennas, enabling precise shaping and steering of the beams. Beamforming algorithms, such as adaptive beamforming or minimum variance distortionless response (MVDR), may be implemented to optimize the beam patterns for interference mitigation and coverage efficiency. The DBFs can ensure that the beams maintain their uniform shape in UV space, even as they project non-uniformly onto the Earth's surface.

In some implementations, the DBFs dynamically adjust beamforming parameters in response to real-time data from the ground network or onboard sensors, allowing the system to adapt to changing interference conditions, scan loss, or satellite motion. The resulting beams illuminate the cells on the Earth's surface while adhering to the frequency assignments and stay-out distance criteria established in the preceding stages.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A system for managing co-channel interference in a satellite communication system, comprising:
a mapping module configured to determine, for one or more satellites of the satellite communication system, locations of a plurality of cells to be illuminated by beams of the one or more satellites in a latitude-longitude coordinate system, and to map the locations of the plurality of cells from the latitude-longitude coordinate system to corresponding locations in a satellite antenna UV-coordinate system;
an interference management module in communication with the mapping module and configured to:
define a stay-out distance between co-channel cells based on an X-decibel beamwidth in the UV coordinate system, where X is a real number corresponding to a predefined interference threshold; and
generate frequency assignments for the beams such that co-channel cells of the plurality of cells are separated by at least the stay-out distance in the UV coordinate system; and
one or more digital beamformers (DBFs) in communication with the interference management module and with one or more satellite antennas of the one or more satellites to direct formation of the beams via based on the frequency assignments such that the beams are uniform in shape and compliant with the stay-out distance in the UV coordinate system.

2. The system of claim 1, further comprising:
a coordination entity configured to:
receive ephemeris data and cell-to-satellite association data for a constellation of the one or more satellites; and
coordinate with the interference management module to generate the frequency assignments across the constellation so that the beams are compliant with the stay-out distance in the UV coordinate system across the constellation.

3. The system of claim 1, wherein the interference management module is configured to generate the frequency assignments for the beams so that the stay-out distance in the UV coordinate system remains substantially constant for all scan angles of the one or more satellite antennas.

4. The system of claim 1, wherein the interference management module is configured to generate the frequency assignments for the beams so that the stay-out distance in the UV coordinate system is adjusted dynamically based on one or more scan-angle-dependent factors.

5. The system of claim 4, wherein the one or more scan-angle-dependent factors includes beam attenuation.

6. The system of claim 1, wherein the interference management module is further configured to adjust the stay-out distance dynamically based on real-time interference conditions measured at user equipment located within the plurality of cells.

7. The system of claim 1, wherein the interference management module is further configured to enforce the stay-out distance in the UV coordinate system by calculating a weighted distance metric based on a combination of UV-space distance, angular separation, and power overlap between co-channel ones of the beams.

8. The system of claim 1, wherein the interference management module is further configured to define the stay-out distance in the UV coordinate system to meet a predefined signal-to-interference ratio (SIR) threshold at an edge of each cell of the plurality of cells.

9. The system of claim 1, wherein the interference management module is further configured to define the stay-out distance in the UV coordinate system by aligning nulls of a first beam with a main lobe of a second beam, the first and second beams being neighboring co-channel beams.

10. The system of claim 1, wherein the interference management module is further configured to generate the frequency assignments using a machine-learning model trained to optimize the stay-out distance in UV space based on historical interference data and predicted beam configurations.

11. The system of claim 1, wherein the mapping module is further configured to generate the UV coordinate system by normalizing cell locations based on the azimuth and elevation angles relative to boresight directions of the one or more satellite antennas.

12. The system of claim 1, wherein the mapping module is configured to map the locations of the plurality of cells into the UV coordinate system to account for curvature of the Earth and relative positions of the one or more satellites.

13. The system of claim 1, wherein the one or more DBFs are configured to implement adaptive beamforming algorithms to dynamically adjust beam shapes and directions in response to real-time interference data received from the interference management module.

14. The system of claim 1, wherein the one or more DBFs are further configured to adjust beamforming parameters so that energy contribution of a co-channel beam at the edge of a neighboring cell does not exceed a predefined interference threshold.

15. The system of claim 1, wherein the one or more satellites are low-Earth orbit (LEO) satellites.

16. A method for managing co-channel interference in a satellite communication system, the method comprising:
mapping locations of a plurality of cells to be illuminated by beams of one or more satellites in a latitude-longitude coordinate system to corresponding locations in a satellite antenna UV-coordinate system;
defining a stay-out distance between co-channel cells based on an X-decibel beamwidth in the UV coordinate system, where X is a real number corresponding to a predefined interference threshold;
generating frequency assignments for the beams such that co-channel cells of the plurality of cells are separated by at least the stay-out distance in the UV coordinate system; and
forming the beams using one or more digital beamformers (DBFs) in communication with one or more satellite antennas of the one or more satellites, such that the beams are uniform in shape and compliant with the stay-out distance in the UV coordinate system.

17. The method of claim 16, wherein generating the frequency assignments comprises ensuring that the stay-out distance in the UV coordinate system remains substantially constant for all scan angles of the one or more satellite antennas.

18. The method of claim 16, wherein generating the frequency assignments comprises dynamically adjusting the stay-out distance in the UV coordinate system based on one or more scan-angle-dependent factors and/or real-time interference conditions measured at user equipment located within the plurality of cells.

19. The method of claim 16, further comprising:
receiving ephemeris data and cell-to-satellite association data for a constellation of the one or more satellites; and
coordinating, across the constellation, the generation of the frequency assignments such that the beams are compliant with the stay-out distance in the UV coordinate system across the constellation.

20. A non-transitory processor-readable medium processor-readable instructions configured to cause one or more processors of a satellite communication system to:
map locations of a plurality of cells to be illuminated by beams of one or more satellites in a latitude-longitude coordinate system to corresponding locations in a satellite antenna UV-coordinate system;
define a stay-out distance between co-channel cells based on an X-decibel beamwidth in the UV coordinate system, where X is a real number corresponding to a predefined interference threshold;
generate frequency assignments for the beams such that co-channel cells of the plurality of cells are separated by at least the stay-out distance in the UV coordinate system; and
cause the beams to be formed using one or more digital beamformers (DBFs) in communication with one or more satellite antennas of the one or more satellites, such that the beams are uniform in shape and compliant with the stay-out distance in the UV coordinate system.
